(19) United States
(12) Patent Application Publication
(10) Pub. No.: US 2006/0098283 A1
(43) Pub. Date: May 11, 2006

(54) Polarization beam splitter and liquid crystal projector apparatus

(76) Inventor: Yoshihisa Sato, Saitama (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/152,566

(22) Filed: Jun. 14, 2005

(30) Foreign Application Priority Data
Jun. 15, 2004 (JP) P2004-176680

(51) Int. Cl. G02B 5/30

(52) U.S. Cl. 359/486; 349/5

(57) ABSTRACT

A polarization beam splitter having an enhanced polarization splitting characteristic is disclosed. The polarization beam splitter includes a first glass prism formed from a pole-like member having side faces which include first and second end faces each of which functions as an incoming face or an outgoing face of light and an opposing face; a second glass prism formed from a pole-like member having side faces which include first and second end faces each of which functions as an incoming face or an outgoing face of light and an opposing face; and a wire grid polarization splitting device formed from a glass substrate and a metal grid formed on a face of the glass substrate; the wire grid polarization splitting device being fixed, at a face of the glass substrate thereof on which the metal grid is not formed, to the opposing face of the first glass prism; the second glass prism being disposed so as to oppose, at the opposing face thereof, to the opposing face of the first glass prism to which the wire grid polarization splitting device is fixed in such a manner that an air layer is formed between the opposing faces.

### BACKGROUND OF THE INVENTION

This invention relates to a polarization beam splitter which splits an incoming light flux into two orthogonally and linearly polarized light fluxes and transmits and emits one of the linearly polarized lights but reflects the other linearly polarized light to perform polarization splitting. The invention further relates to a liquid crystal projector apparatus in which the polarization beam splitter is used.

A liquid crystal projector apparatus of the type described is disclosed, for example, in Japanese Patent Laid-Open No. 2003-131212 (hereinafter referred to as Patent Document 1).

In a reflection type liquid crystal projector apparatus in which a reflection type liquid crystal panel is used, an incoming portion and an outgoing portion of light to and from the liquid crystal panel are same as each other. Therefore, it is necessary to perform polarization splitting using a polarization beam splitter or a like device.

FIG. 12A shows a basic optical system of a reflection type liquid crystal projector apparatus.

Referring to FIG. 12A, light emitted from a light source (discharge lamp) 102 is converted into a light flux of substantially parallel light by a reflecting mirror 106. Then, the light flux is condensed and illuminated on a reflection type liquid crystal panel 104 by an illumination optical system 103 and a polarization beam splitter 101 which servers as a polarization splitting device.

Referring to FIG. 12B, the polarization beam splitter 101 disposed forwardly of the reflection type liquid crystal panel 104 reflects S polarized light (with respect to a polarization splitting face of the polarization beam splitter) but transmits P polarized light therethrough. Accordingly, in the reflection type liquid crystal projector apparatus shown in FIG. 12A, the P polarized light component is directed to the reflection type liquid crystal panel 104.

A video signal Sv is applied to the reflection type liquid crystal panel 104. The reflection type liquid crystal panel 104 applies an electric field in accordance with the applied video signal Sv to a liquid crystal unit provided therein. The array of liquid crystal molecules varies in response to the applied electric field. An optical rotating power is provided by the arrangement of the liquid crystal molecules, and incoming light is rotationally polarized by and then emitted from the reflection type liquid crystal panel 104.

The panel emerging light forms an optical image corresponding to the video signal Sv and enters the polarization beam splitter 101 again. By the reflection type liquid crystal panel 104, only the S polarized light (with respect to the polarization splitting face of the polarization beam splitter) whose oscillation direction of polarization is rotated is reflected by the polarization splitting face of the polarization beam splitter 104 and directed toward to a projection lens 105.

The projection lens 105 projects and outputs the optical image formed on the reflection type liquid crystal panel 104. Consequently, a video is projected and displayed.

The polarization beam splitter 101 is formed by adhering glass prisms each formed from a pole-like member to each other, or more particularly, by adhering two right isosceles triangular prisms made of glass to each other. A multilayer optical thin film is laminated by vapor deposition on the adhered faces and performs polarization splitting.

However, in such a polarization beam splitter for which a glass prism is used as described above, in order to enhance the polarization splitting characteristic (extinction ratio in transmission or reflection of P polarized light and S polarized light), it is necessary to receive light of a high F number, that is, light near to parallel light, as incoming light.

Thus, various techniques for enhancing the polarization splitting characteristic have been proposed. One of the techniques is disclosed in Patent Document 1 mentioned hereinabove. According to the technique disclosed in the document, a polarization splitting device in which a wire grid is used is sandwiched by right isosceles triangular prisms made of glass.

A structure of a wire grid polarization splitting device is shown in FIGS. 11A and 11B.

A wire grid polarization splitting device 4 includes a parallel striped metal grid 4c formed from a metal such as aluminum on a face (metal grid structure face) 4a of a glass substrate 4b.

As shown in FIGS. 11A and 11B, where it is assumed that the width and the height of the individual metal stripes which form the metal grid 4c are represented by w and h, respectively, and the formation cycle (pitch) of the metal stripes is represented by p, if the metal grid 4c is formed in a substantially short cycle p which is about ⅕ or less with respect to the wavelength of incoming light, then light having an electric field component which oscillates in a vertical direction with respect to a cycle direction is reflected while light having an electric field component which oscillates in a parallel direction is transmitted, and light absorption little occurs. Therefore, the polarization splitting can be performed efficiently.

Therefore, as shown in FIG. 11C, when natural light directed at a certain incoming angle to the wire grid polarization splitting device 4, reflected light is converted into S polarized light with respect to the incoming face of the wire grid polarization splitting device 4. Meanwhile, transmitted light is converted into P polarized light with respect to the incoming face.

It is known that such a wire grid polarization splitting device 4 as described above has an advantage that the polarization splitting characteristic is high and variation of a spectral transmission coefficient with respect to an incoming angle is small.

In the polarization splitting device disclosed in Patent Document 1, the right isosceles triangular prisms made of glass sandwich the wire grid polarization splitting device therebetween to form a polarization beam splitter having a good polarization splitting characteristic.

### SUMMARY OF THE INVENTION

However, the polarization beam splitter disclosed in Patent Document 1 has such problems as described below.

First, it is difficult to implement an expected polarization splitting performance.

According to the technique disclosed in Patent Document 1, the wire grid polarization splitting device is sandwiched by and adhered to the right isosceles triangular prisms so as to be integrated with each other. However, the wire grid polarization splitting device includes the metal grid 4c in the form of metal stripes of a very small size extending in parallel to each other as described above. The height of the metal grid 4c is approximately 100 to 200 nm, and the width of the metal stripes of the metal grid 4c is approximately 50 to 100 nm.

If the right isosceles triangular prism is adhered to the face on which such a metal grid as described above is formed, then the grid is broken by the adhesive, and it is often the case that a desired polarization splitting performance is not exhibited.

Further, even if the metal grid is not broken, there is such a problem as described below. If the opposite side of the wire grid plate, that is, the side of the face on which the metal grid is formed, does not have an index of refraction of 1, then the desired performance cannot be exhibited readily. The index of refraction=1 is given by the air. Therefore, where the wire grid plate is sandwiched by the right isosceles triangular prisms, a sufficient performance is not exhibited.

As described above, it is demanded to provide a polarization beam splitter employing a wire grid polarizing splitting device which eliminates the problems described above and has a high performance. Also it is demanded to provide a liquid crystal projector apparatus which has a high performance and is implemented using a polarization beam splitter.

According to an embodiment of the present invention, there is provided a polarization beam splitter including a first glass prism formed from a pole-like member having side faces which include first and second end faces each of which functions as an incoming face or an outgoing face of light and an opposing face, a second glass prism formed from a pole-like member having side faces which include first and second end faces each of which functions as an incoming face or an outgoing face of light and an opposing face, and a wire grid polarization splitting device formed from a glass substrate and a metal grid formed on a face of the glass substrate, the wire grid polarization splitting device being fixed, at a face of the glass substrate thereof on which the metal grid is not formed, to the opposing face of the first glass prism, the second glass prism being disposed so as to oppose, at the opposing face thereof, to the opposing face of the first glass prism to which the wire grid polarization splitting device is fixed in such a manner that an air layer is formed between the opposing faces.

Preferably, the first and second glass prisms are fixed at upper and bottom faces of the pole-like members thereof to fixing plates such that the opposing faces of the first and second glass prisms are disposed fixedly relative to each other with the air layer formed therebetween.

Alternatively, end portions of the opposing faces of the first and second glass prisms or end portions of the wire grid polarization splitting device fixed to the opposing face may be fixed to spacers such that the opposing faces are disposed fixedly relative to each other with the air layer formed therebetween.

The polarization beam splitter may further include a second wire grid polarization splitting device formed from a glass substrate and a metal grid formed on a face of the glass substrate, the second wire grid polarization splitting device being fixed, at a face of the glass substrate thereof on which the metal grid is not formed, to the opposing face of the first glass prism.

In summary, the polarization beam splitter is formed from a wire grid polarization splitting device and first and second glass prisms, and the wire grid polarization splitting device is fixed, at a face of the glass substrate thereof on which the metal grid is not formed, to one of the glass prisms. Further, the metal grid side is opposed to the other glass prism side with an air layer left therebetween. In other words, the metal grid side is prevented from contacting with the other glass prism side.

Accordingly, while the wire grid polarization splitting device is disposed at a position at which it is sandwiched by the first and second glass prisms to form the polarization beam splitter, the metal grid face side of the wire grid polarization splitting device is structured such that an air layer (air gap) is formed. In other words, since the metal grid side is not adhered to any glass prism, such a situation that the metal grid is broken by an adhesive cannot occur at all.

Further, since the air layer whose refractive index is 1 is positioned on the metal grid face, the wire grid polarization splitting device can exhibit its original polarization splitting performance.

From the foregoing, the polarization beam splitter can be implemented with a higher performance.

Further, assurance of a space which makes the air layer on the metal grid side can be implemented readily by a structure that the first and second glass prisms are fixed at upper and bottom faces of the pole-like members thereof to fixing plates or by another structure that end portions of the opposing faces of the first and second glass prisms or end portions of the wire grid polarization splitting device fixed to the opposing face are fixed to spacers.

Furthermore, the polarization splitting function can be further enhanced by fixing the wire grid polarization splitting device to both of the opposing faces of the first and second glass prisms, that is, by using two wire grid polarization splitting devices.

According to another embodiment of the present invention, there is provided a liquid crystal projector apparatus including a light source, a reflection type liquid crystal panel for forming an optical image in response to a video signal, a projection lens, and a polarization beam splitter for polarizing and splitting process light introduced along a predetermined light path from the light source and introducing the resulting light to the reflection type liquid crystal panel and for polarizing and splitting the light reflected by the reflection type liquid crystal panel and introducing the resulting light to the projection lens, the polarization beam splitter including a first glass prism formed from a pole-like member having side faces which include first and second end faces each of which functions as an incoming face or an outgoing face of light and an opposing face, a second glass prism formed from a pole-like member having side faces which include first and second end faces each of which functions as an incoming face or an outgoing face of light and an opposing face, and a wire grid polarization splitting device formed from a glass substrate and a metal grid formed on a face of the glass substrate, the wire grid polarization splitting device being fixed, at a face of the glass substrate thereof on which the metal grid is not formed, to the opposing face of the first glass prism, the second glass prism being disposed so as to oppose, at the opposing face thereof, to the opposing face of the first glass prism to which the wire grid polarization splitting device is fixed in such a manner that an air layer is formed between the opposing faces.

The liquid crystal projector apparatus may be configured such that the predetermined light path includes splitting optical means for splitting white light from the light source into red, green, and blue light fluxes, the reflection type liquid crystal panel including first, second and third reflection type liquid crystal panels for forming an optical image in response to video signals of red, green and blue colors, the polarization beam splitter includes first, second and third polarization beam splitters which correspond to the red, green and blue light fluxes split by the splitting optical means and the first, second and third reflection type liquid crystal panels, respectively, the liquid crystal projector apparatus further including light synthesizing means for synthesizing the red, green and blue light fluxes reflected by the first to third reflection type liquid crystal panels and polarized and split by the first to third polarization beam splitters and introducing the synthesized light to the projection lens.

In the liquid crystal projector apparatus, preferably the first and second glass prisms of the polarization beam splitter are fixed at upper and bottom faces of the pole-like members thereof to fixing plates such that the opposing faces of the first and second glass prisms are disposed fixedly relative to each other with the air layer formed therebetween.

Alternatively, end portions of the opposing faces of the first and second glass prisms of the polarization beam splitter or end portions of the wire grid polarization splitting device fixed to the opposing face may be fixed to spacers such that the opposing faces are disposed fixedly relative to each other with the air layer formed therebetween.

Further, the liquid crystal projector apparatus may be configured such that the polarization beam splitter further includes a second wire grid polarization splitting device formed from a glass substrate and a metal grid formed on a face of the glass substrate, the second wire grid polarization splitting device being fixed, at a face of the glass substrate thereof on which the metal grid is not formed, to the opposing face of the second glass prism.

In summary, the liquid crystal projector apparatus can achieve a high efficiency by using, as a polarization beam splitter to be provided corresponding to the reflection type liquid crystal panel, the polarization beam splitter having the above-described configuration and hence having an enhanced polarization splitting characteristic.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIGS. 1A and 1B are schematic views showing a basic structure of a polarization beam splitter to which the present invention is applied;

FIGS. 2A and 2B are schematic views showing polarization splitting operation of the polarization beam splitter of FIG. 1;

FIG. 3 is a perspective view showing a structure of the polarization beam splitter of FIG. 1;

FIG. 4 is a schematic view showing another example of the structure of the polarization beam splitter of FIG. 1;

FIGS. 5A and 5B are schematic views showing different examples of the shape of a glass prism of the polarization beam splitter of FIG. 1;

FIGS. 6A and 6B are schematic views showing polarization beam splitters in which two wire grid polarization splitting devices are used;

FIGS. 7 to 10 are schematic views showing different examples of an optical system of a liquid crystal projector apparatus to which the present invention is applied;

FIGS. 11A to 11C are schematic views showing a wire grid polarization splitting device; and

FIGS. 12A and 12B are schematic views showing an optical system of a related-art liquid crystal projector apparatus.

### DETAILED DESCRIPTION OF THE PREFERRED EMBODIMENT

In the following, several polarization beam splitters to which the present invention is applied and several liquid crystal projector apparatus in which the polarization beam splitters are used are described.

<Polarization Beam Splitters>

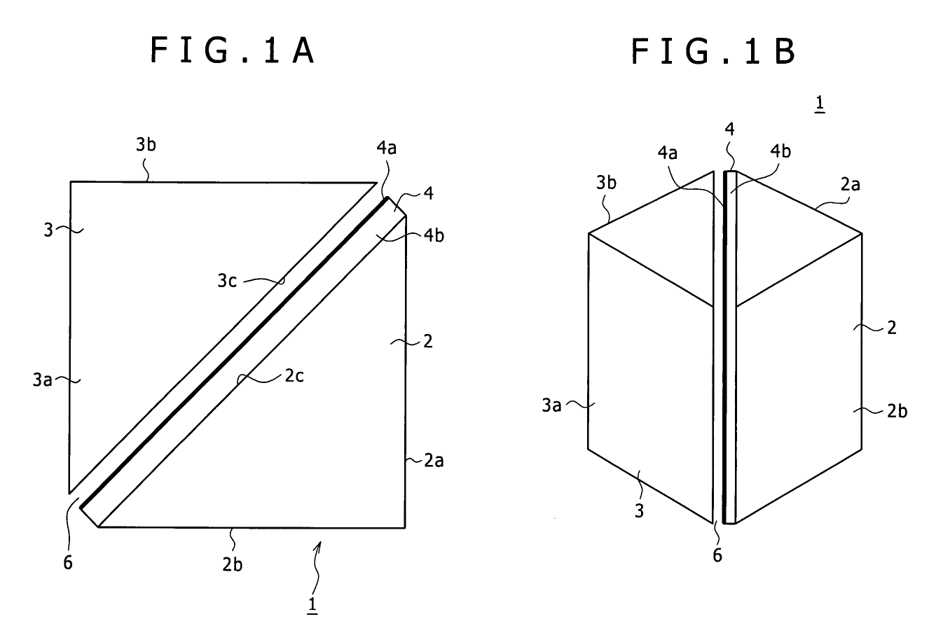

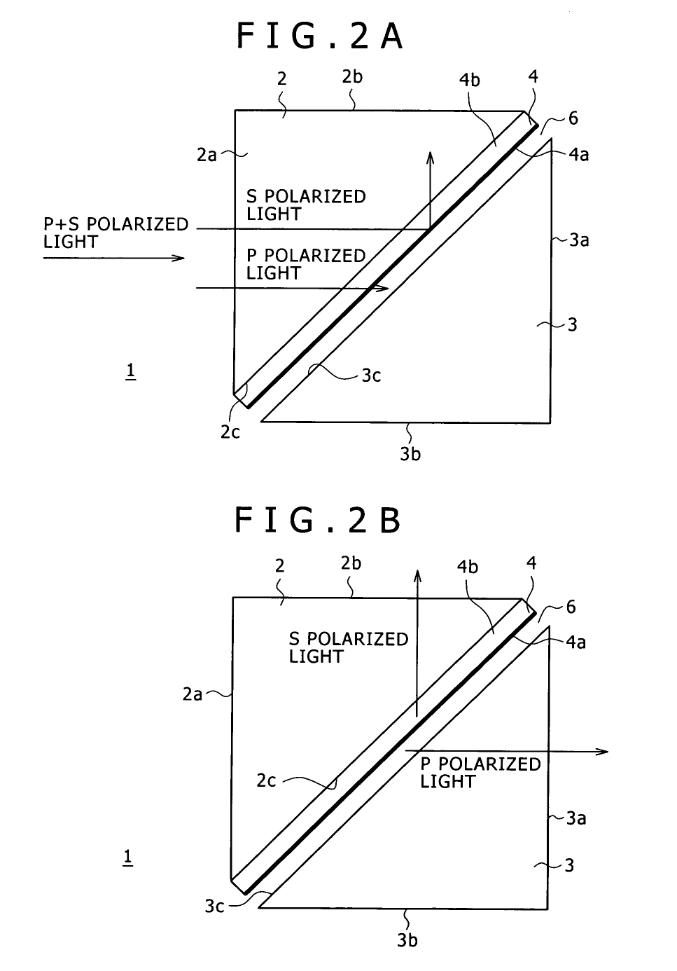

First, a basic configuration of a polarization beam splitter to which the present invention is applied is described with reference to FIGS. 1A to 2B.

The polarization beam splitter 1 of the present embodiment shown includes a pair of glass prisms 2 and 3 each formed from a pole-like member and a wire grid polarization splitting device 4. Particularly, the glass prisms 2 and 3 are formed as right isosceles triangular prisms.

The glass prism 2 has three side faces 2a, 2b and 2c which correspond to the three sides of a right isosceles triangular shape. Each of the side faces 2a and 2b functions as an incoming face or an outgoing face when the polarization beam splitter 1 is disposed on a light path. The side face 2c functions as an opposing face opposed to the glass prism 3.

Similarly to the glass prism 2, the glass prism 3 has three side faces 3a, 3b and 3c corresponding to the three sides of a right isosceles triangular shape. Each of the side faces 3a and 3b functions as an incoming face or an outgoing face when the polarization beam splitter 1 is disposed on a light path. The side face 3c functions as an opposing face opposed to the glass prism 2.

Any of the side faces 2a, 2b, 3a and 3b is hereinafter referred to as incoming face or an outgoing face in response to a light path formed. Any of the side faces 2c and 3c is hereinafter referred to as opposing face.

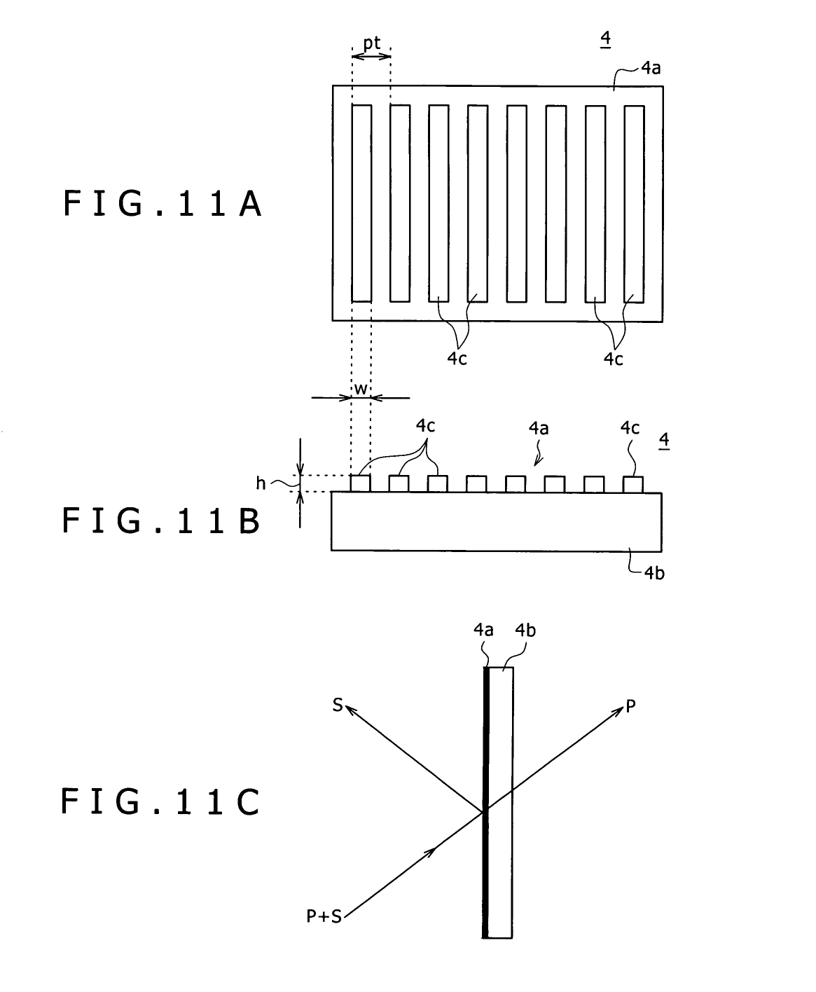

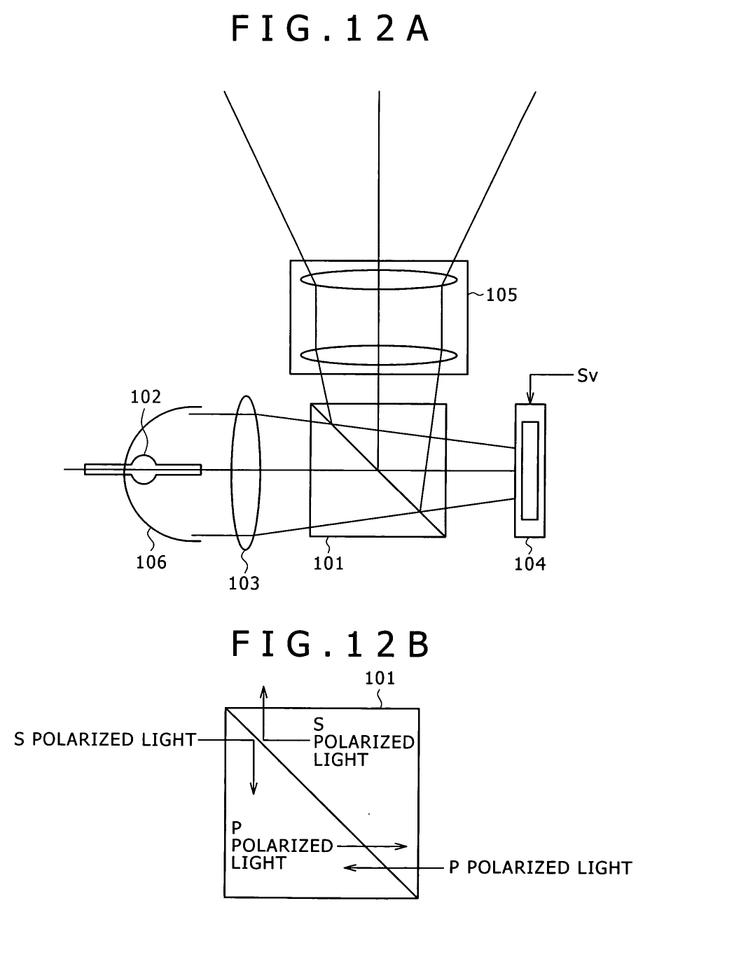

The wire grid polarization splitting device 4 has such a structure as described hereinabove with reference to FIGS. 11A to 11C. In particular, a metal grid 4c is provided in a predetermined pitch on a face of a glass substrate 4b to form a metal grid structure face 4a.

As shown in FIGS. 1A and 1B, the polarization beam splitter 1 is formed by disposing the wire grid polarization splitting device 4 between the two right isosceles triangular prisms 2 and 3 which are made of glass.

At this time, the glass substrate 4b of the wire grid polarization splitting device 4 is fixedly adhered to the opposing face 2c of the glass prism 2 by an adhesive.

On the other hand, the metal grid structure face 4a of the wire grid polarization splitting device 4 opposes to the opposing face 3c of the glass prism 3 with an air gap (air layer) 6 left therebetween. In other words, the metal grid structure face 4a is not adhered to the opposing face 3c.

Operation of the polarization beam splitter 1 wherein the air gap 6 and the wire grid polarization splitting device 4 are disposed between the glass prisms 2 and 3 in this manner is described with reference to FIGS. 2A and 2B.

It is assumed that light enters through the incoming face 2a of the glass prism 2 as seen in FIG. 2A. The incoming light includes P polarized light and S polarized light.

First, the incoming light enters the glass prism 2. Then, the incoming light comes to the adhering face between the glass prism 2 and the wire grid polarization splitting device 4. Then, when the incoming light comes to the metal grid structure face 4a of the wire grid polarization splitting device 4, the S polarized light is reflected by the metal grid structure face 4a, but the P polarized light is transmitted through the metal grid structure face 4a.

Thereafter, the S polarized light enters the glass prism 2 again and emerges from the outgoing face 2b as shown in FIG. 2B. On the other hand, the P polarized light transmits the air gap 6 and enters the glass prism 3. Then, the P polarized light is transmitted through the glass prism 3 and emerges from the outgoing face 3a.

Where the polarization beam splitter 1 has such a configuration as described above, while the wire grid polarization splitting device 4 is disposed at a position sandwiched by the glass prisms 2 and 3, since the air gap 6 is formed on the metal grid structure face 4a side, the metal grid structure face 4a is not adhered to the glass prism 3 by any adhesive. Therefore, such a situation that the metal grid 4c is broken by an adhesive does not occur at all. Further, since the air gap 6 of the index of refraction=1 is provided on the metal grid structure face 4a side, an original polarization splitting performance of the wire grid polarization splitting device 4 can be exhibited. Accordingly, a high-performance polarization beam splitter can be implemented.

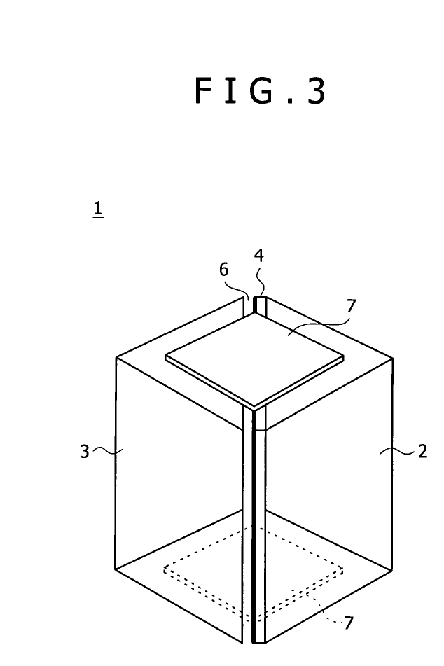

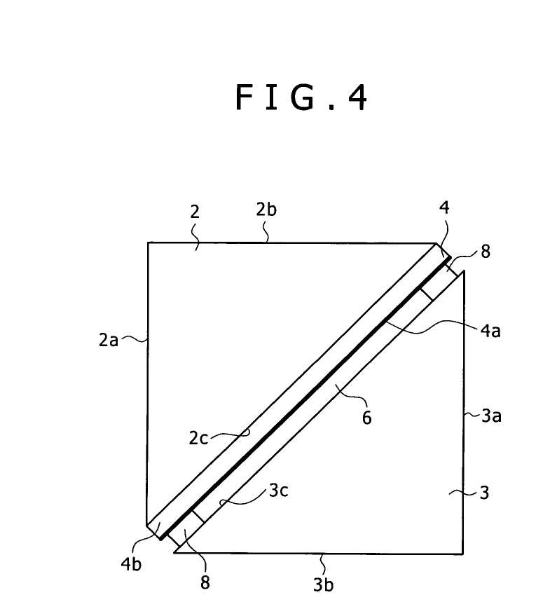

Different examples of the structure for disposing the wire grid polarization splitting device 4 in a state wherein the air gap 6 is formed between the glass prisms 2 and 3 as described above with reference to FIGS. 1A and 1B are described with reference to FIGS. 3 and 4.

FIG. 3 shows an example of the polarization beam splitter in which fixing plates 7 are used.

As shown in FIG. 3, upper faces and bottom faces of the glass prisms 2 and 3 are individually adhered fixedly to each other by the fixing plates 7. Where the glass prisms 2 and 3 are fixed by the fixing plates 7 in this manner, the polarization beam splitter 1 wherein the air gap 6 is formed as described above can be implemented. The size and shape of the fixing plates 7 are not limited if the upper faces and the bottom faces of the glass prisms 2 and 3 can be fixed to each other.

FIG. 4 shows an example of the polarization beam splitter in which a spacer 8 is used.

As shown in FIG. 4, an end of the metal grid structure face 4a of the wire grid polarization splitting device 4 which is adhered to the opposing face 2c of the glass prism 2 and an end of the opposing face 3c of the glass prism 3 are fixedly adhered to each other with spacers 8 interposed therebetween. Naturally, the ends to which the spacers 8 are to be adhered are portions wherein light does not enter on the metal grid structure face 4a.

The spacers 8 may be provided on the four sides of the opposing face 3c so as to enclose the face 3c, or may be provided at least on two sides.

For example, where the polarization beam splitter is configured in such a manner as shown in FIGS. 3 and 4, the beam splitter 1 of the present embodiment can be implemented.

It is to be noted that a structure may be applied wherein the spacers 8 are used as shown in FIG. 4, and besides, the upper faces and bottom faces of the glass prisms 2 and 3 are fixed by the fixing plates 7, respectively.

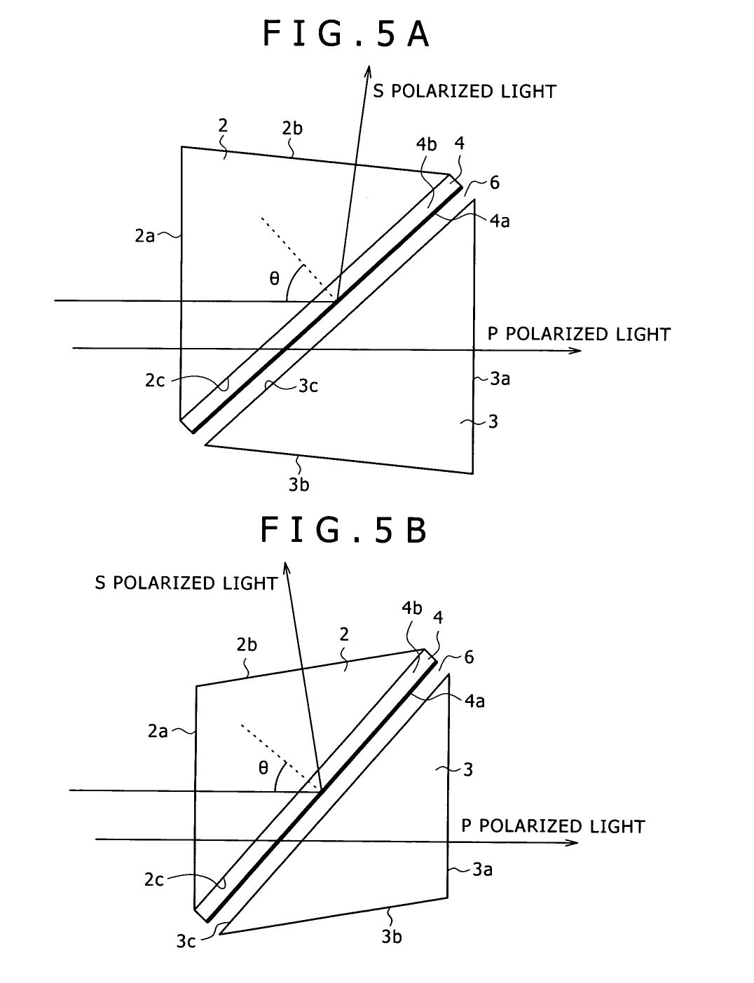

FIGS. 5A and 5B show different examples of the configuration of the polarization beam splitter 1.

The polarization beam splitter 1 described above with reference to FIGS. 1A to 4 has a structure wherein the incoming angle of light to the metal grid structure face 4a of the wire grid polarization splitting device 4 is 45 degrees and the glass prisms 2 and 3 have a right isosceles triangular cross section. However, also such structures as shown in FIGS. 5A and 5B may be applied wherein the incoming angle of light is different from 45 degrees.

FIG. 5A shows an example of a structure wherein the incoming angle θ is greater than 45 degree, and FIG. 5B shows another example of a structure wherein the incoming angle θ is smaller than 45 degree.

In particular, the triangular glass prisms 2 and 3 may have an arbitrary sectional shape and may be formed in a required shape for forming a necessary light path and/or a necessary incoming angle.

It is to be noted that the wire grid polarization splitting device 4 has a characteristic that the P/S spectral splitting characteristic scarcely varies with respect to the incoming angle. Therefore, even if the shape of the glass prisms 2 and 3 is determined based on an incoming light path and an outgoing light path required for the polarization beam splitter 1, the splitting characteristic does not deteriorate at all.

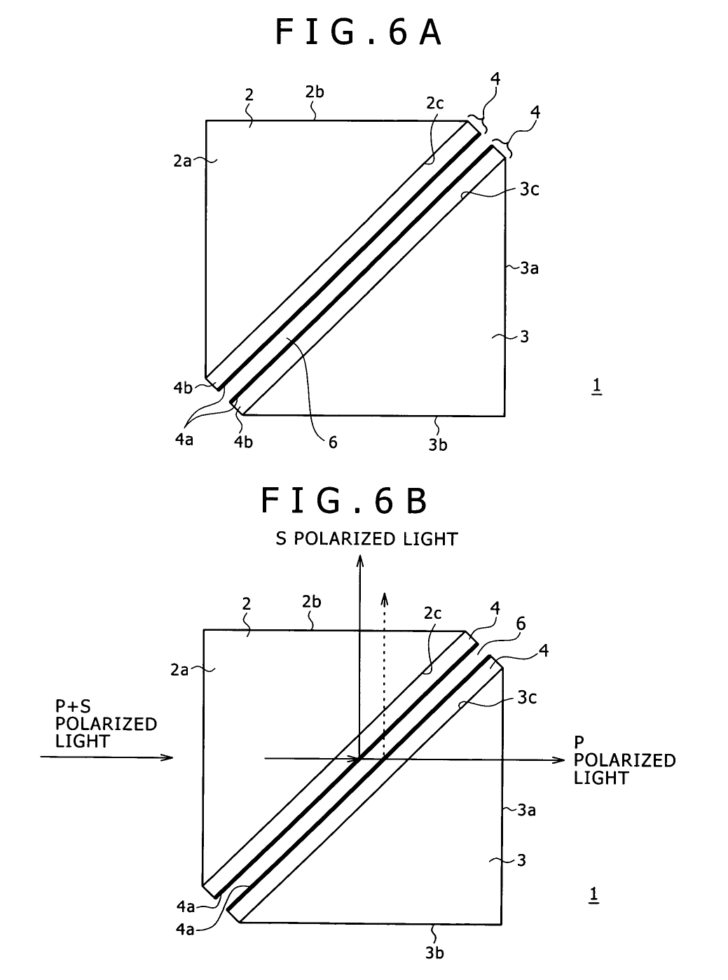

FIGS. 6A and 6B show a different example of a configuration of the polarization beam splitter in which two wire grid polarization splitting device 4 are provided.

Referring to FIG. 6A, a wire grid polarization splitting device 4 is adhered not only on the opposing face 2c of the glass prism 2 but also on the opposing face 3c of the glass prism 3. The air gap 6 is formed between the wire grid polarization splitting devices 4 opposed to each other (between the metal grid structure faces 4a).

At this time, the directions of the grooves of the metal grids 4c of the wire grid polarization splitting devices 4 are same as each other.

It is to be noted that also the polarization beam splitter 1 having such a configuration as shown in FIG. 6A can be implemented by utilizing such fixing plates 7 as shown in FIG. 3 or by utilizing such a spacer 8 as shown in FIG. 4.

Where the two wire grid polarization splitting devices 4 are disposed in such a manner as seen in FIG. 6A, the polarization splitting characteristic can be further enhanced. In particular, referring to FIG. 6B, light incoming, for example, through the incoming face 2a is reflected at S polarized light thereof by the metal grid structure face 4a of the wire grid polarization splitting device 4 adhered to the glass prism 2 while it is transmitted at P polarized light thereof through the metal grid structure face 4a. Nevertheless, also a very small amount of the slight S polarized light component is transmitted through the metal grid structure face 4a. Also the transmitted S polarized light component enters the metal grid structure face 4a of the wire grid polarization splitting device 4 adhered to the glass prism 3 together with the P polarized light. At this time, the transmitted S polarized light component is reflected as indicated by a broken line in FIG. 6B.

In other words, since the polarized light section process is performed twice by the two wire grid polarization splitting devices 4, the polarization splitting characteristic can be enhanced.

While various examples of the configuration of the polarization beam splitter 1 are described above, further various configurations are considered available.

Preferably, in the wire grid polarization splitting device 4 used in the polarization beam splitter 1, the cycle of the stripes of the metal grid 4c is 120 nm or less and the height of the metal grid 4c is approximately 180 nm.

Further, each of the glass prisms 2 and 3 may not necessarily be a triangular prism. Naturally, even where it is formed as a triangular prism, each of the glass prisms 2 and 3 may not have a precisely triangular shape because it is chamfered. Or, each of the glass prisms 2 and 3 may be formed in a polygonal cross sectional shape such as a square shape or more. Anyway, it is only necessary for each of the glass prisms 2 and 3 to have a shape necessary for formation of a polarization path required for the polarization beam splitter 1.

Further, the glass prisms 2 and 3 are not influenced by double refraction if the photoelastic coefficient of the material glass is 0.5×10⁻⁸ [cm²/N] or less.

Further, also it is considered that a coating for reducing the interface reflection may be applied to the incoming and/or outgoing faces (2a, 2b, 3a, 3b) of the glass prisms 2 and 3.

<Reflection Type Liquid Crystal Projector Apparatus>

Now, examples of a configuration of an optical system of a reflection type liquid crystal projector apparatus in which the polarization beam splitter 1 described above is used is described.

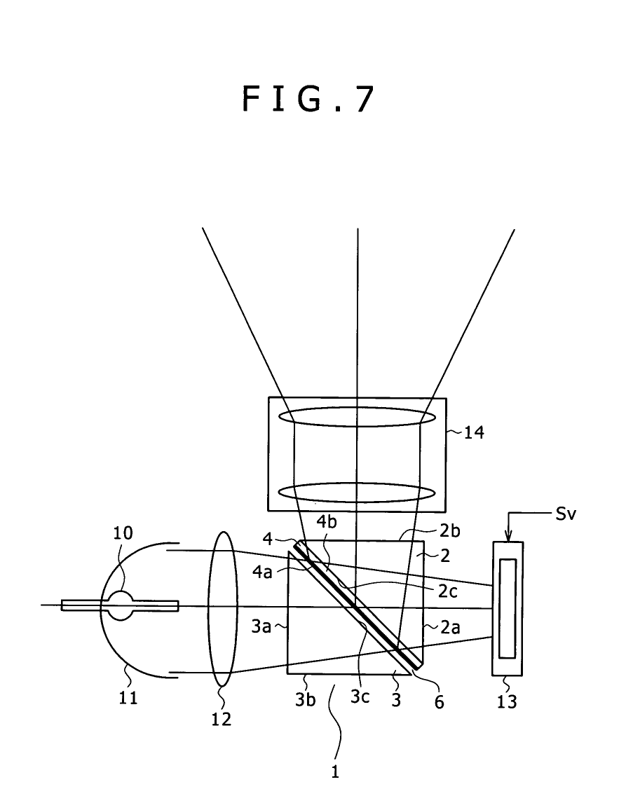

FIG. 7 shows a basic configuration of an optical system as an example wherein P polarized light is introduced to the reflection type liquid crystal panel 13. Here, the polarization beam splitter 1 has a structure wherein the wire grid polarization splitting device 4 is adhered to the glass prism 2 side.

Light emitted from a light source (discharge lamp) 10 is converted into a light flux of substantially parallel light by a reflecting mirror 11. Then, the resulting light comes to the incoming face 3a of the polarization beam splitter 1 through an illumination optical system 12. Then, the light enters the glass prism 3 of the polarization beam splitter 1 through the incoming face 3a and comes to the air gap 6 through the opposing face 3c. Thereafter, the light is polarized and split by the metal grid structure face 4a of the wire grid polarization splitting device 4. Consequently, only P polarized light enters the glass prism 2. Then, the P polarized light emerges from the outgoing face 2a and is condensed and illuminated on the reflection type liquid crystal panel 13.

A video signal Sv is applied to the reflection type liquid crystal panel 13. The reflection type liquid crystal panel 13 applies an electric field in accordance with the applied video signal Sv to an internal liquid crystal unit. The arrangement of liquid crystal molecules varies in response to the applied electric field. An optical rotating power is provided by the arrangement of the liquid crystal molecules, and consequently, the incoming light is rotationally polarized by and then emerges from the reflection type liquid crystal panel 13.

The S polarized light of the panel emerging light forms an optical image corresponding to the video signal Sv and enters the polarization beam splitter 1 again through the incoming face 2a. Then, the panel emerging light is transmitted through the glass prism 2 and comes to the metal grid structure face 4a of the wire grid polarization splitting device 4. Then, only the S polarized light is reflected by the metal grid structure face 4a and directed from the outgoing face 2b to a projection lens 14.

The projection lens 14 projects and outputs the optical image formed by the reflection type liquid crystal panel 13. Consequently, the image is projected and displayed in an enlarged scale. In this instance, the panel emerging light is enlarged and projected by the projection lens 14 without transmitted through the air gap 6 of the polarization beam splitter 1. Therefore, astigmatism of the light which appears upon transmission of the light through the air gap 6 does not appear at all, and consequently, a good projected image can be obtained.

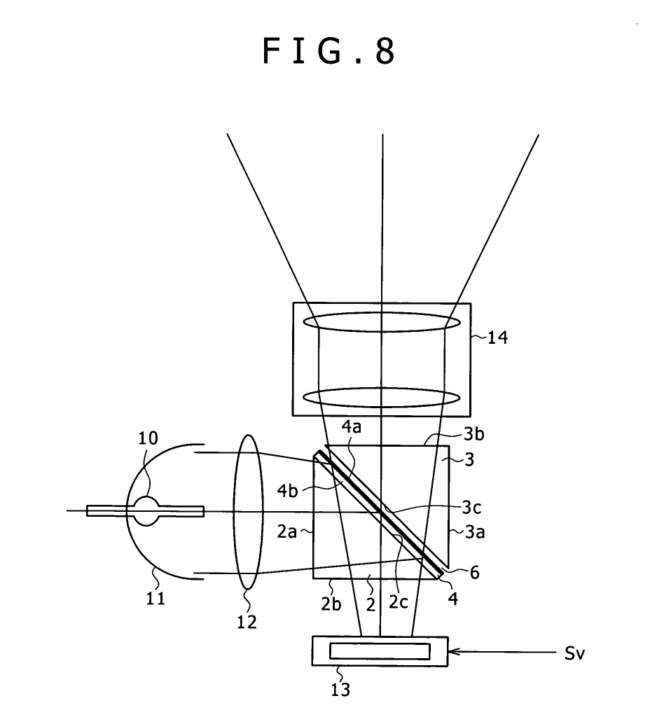

FIG. 8 shows a basic configuration of the optical system as an example wherein S polarized light is introduced to the reflection type liquid crystal panel 13. Similarly as in FIG. 7, the polarization beam splitter 1 has a structure wherein the wire grid polarization splitting device 4 is adhered to the glass prism 2 side.

Light emitted from the light source 10 is converted into a light flux of substantially parallel light by the reflecting mirror 11 and, and the resulting light comes to the incoming face 2a of the polarization beam splitter 1 through the illumination optical system 12.

The light enters the glass prism 2 of the polarization beam splitter 1 through the incoming face 2a and is polarized and split by the metal grid structure face 4a of the wire grid polarization splitting device 4. Then, the resulting P polarized light is transmitted directly through the air gap 6 and comes to the glass prism 3 side while the S polarized light is reflected by the metal grid structure face 4a and emerges from the outgoing face 2b such that it is condensed on and illuminates the reflection type liquid crystal panel 13.

Then, the panel emerging light rotationally polarized by and emerging from the reflection type liquid crystal panel 13 to which the video signal Sv is applied enters the polarization beam splitter 1 through the incoming face 2b again. Then, the light is transmitted through the glass prism 2 and comes to the metal grid structure face 4a of the wire grid polarization splitting device 4. Then, only the P polarized light is transmitted through the metal grid structure face 4a and directed to the projection lens 14. The projection lens 14 projects and outputs the optical image formed on the reflection type liquid crystal panel 13. Consequently, a video is projected and displayed in an enlarged scale.

In this manner, S polarized light may be introduced to the reflection type liquid crystal panel 13. It is to be noted that, in this instance, although, when the panel emerging light is enlarged and projected by the projection lens 14, it suffers from astigmatism caused by the air gap 6 of the polarization beam splitter 1, the astigmatism can be reduced to an ignorable level by minimizing the size of the gap (gap width) in the form of the air gap 6.

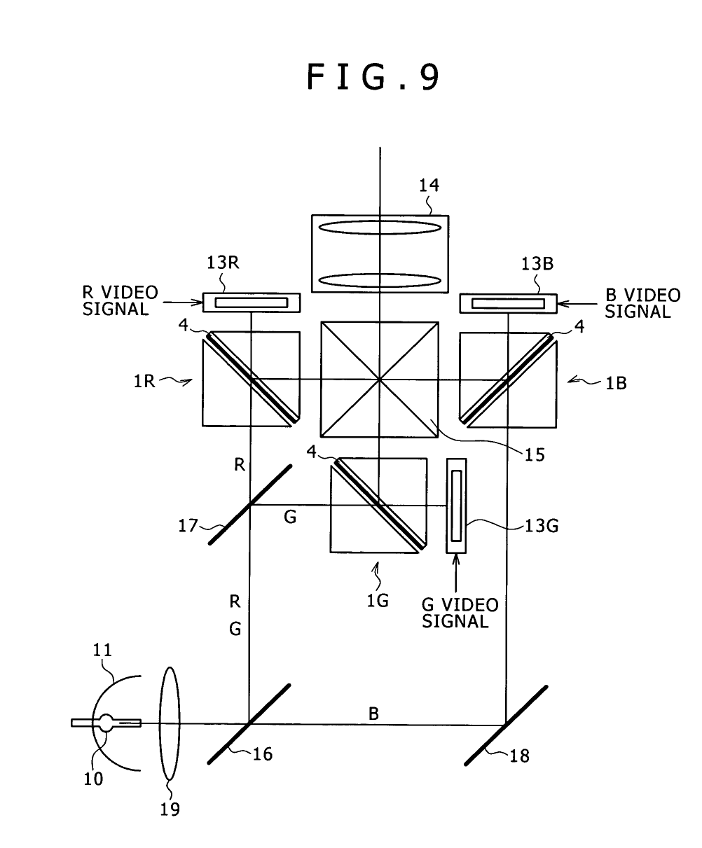

Now, an example of an optical system for a reflection type liquid crystal projector apparatus which includes three polarization beam splitters 1 and three liquid crystal panels 13 corresponding to the three primary colors of red (R), green (G) and blue (B) is described with reference to FIG. 9.

The polarization beam splitters 1R, 1G and 1B have a configuration similar to that of the polarization beam splitter 1 described hereinabove with reference to FIGS. 7 and 8.

The liquid crystal panels 13R, 13G and 13B are supplied with video signals as an R signal, a G signal and a B signal, respectively.

White light emitted from the light source 10 and converted into a flux of substantially parallel light by the reflecting mirror 11 is transmitted through a lens 19 and comes first to a dichroic mirror 16, by which only the B light is transmitted while the R light and the G light are reflected.

The R light and the G light come to another dichroic mirror 17, by which the R light is transmitted while the G light is reflected.

The lights of the three primary colors of R, G and B split by the dichroic mirrors 16 and 17 enter the polarization beam splitters 1R, 1G and 1B, respectively.

The reflection type liquid crystal panels 13R, 13G and 13B are disposed at positions of the metal grid structure faces 4a of the polarization beam splitters 1R, 1G and 1B to which P polarized light comes in, respectively. In other words, the liquid crystal panels 13R, 13G and 13B are disposed so as to receive the P polarized light entering the same.

First, the R light transmitted through the dichroic mirror 17 is polarized and split by the wire grid polarization splitting device 4 of the polarization beam splitter 1R. Thus, only the P polarized light of the R light is transmitted through the wire grid polarization splitting device 4 and comes to the reflection type liquid crystal panel 13R. The reflection type liquid crystal panel 13R modulates the incoming light with the R video signal applied thereto and emits the modulated light. The S polarized light of the outgoing light from the reflection type liquid crystal panel 13R is selected by the polarization beam splitter 1R and enters a color synthesizing prism 15.

The G light reflected by the dichroic mirror 17 is polarized and split by the polarization beam splitter 1G, and only the P polarized light of the G light is transmitted through the polarization beam splitter 1G and comes to the reflection type liquid crystal panel 13G. The reflection type liquid crystal panel 13G modulates the incoming light with the G video signal applied thereto and emits the modulated light. The S polarized light of the outgoing light from the reflection type liquid crystal panel 13G is selected by the polarization beam splitter 1G and enters the color synthesizing prism 15.

The B light transmitted through the dichroic mirror 16 is reflected by a mirror 18 and then polarized and split by the polarization beam splitter 1B, and only the P polarized light of the B light is transmitted through the polarization beam splitter 1B and comes to the reflection type liquid crystal panel 13B. The reflection type liquid crystal panel 13B modulates the incoming light with the B video signal applied thereto and emits the modulated light. The S polarized light of the outgoing light from the reflection type liquid crystal panel 13B is selected by the polarization beam splitter 1B and enters the color synthesizing prism 15.

The color synthesizing prism 15 synthesizes the incoming R, G and B lights and emits them toward the same direction. Consequently, the synthesized light is magnified and projected as a color video by the projection lens 14.

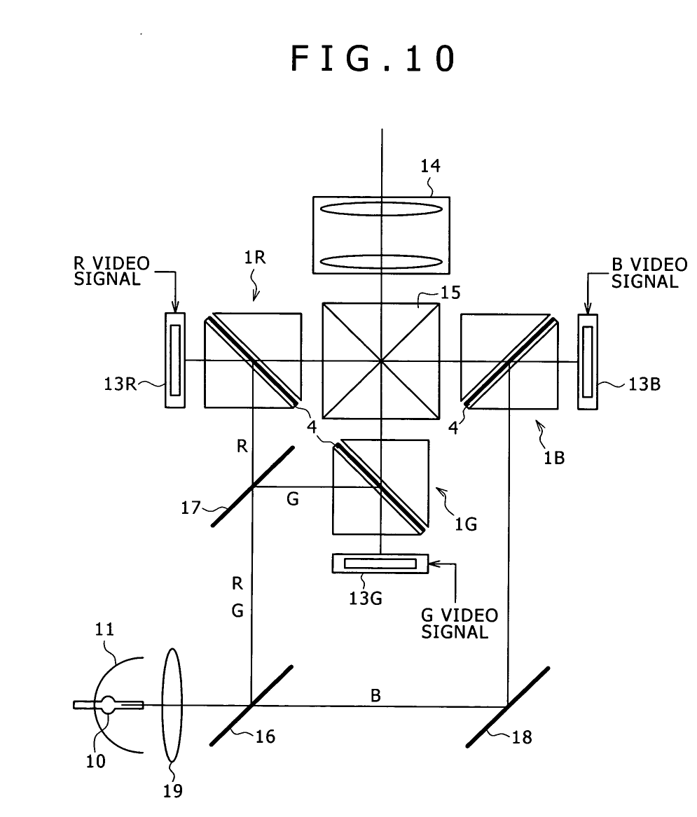

FIG. 10 shows another example of an optical system for a reflection type liquid crystal projector apparatus which includes three polarization beam splitters 1 and three liquid crystal panels 13 corresponding to the three primary colors of red (R), green (G) and blue (B). In the example of FIG. 10, however, S polarized light is introduced to the liquid crystal panels 13R, 13G and 13B.

Referring to FIG. 10, the optical system shown includes a light source 10, a reflecting mirror 11, a lens 19, dichroic mirrors 16 and 17 and a mirror 18 similar to those described hereinabove with reference to FIG. 9.

The light fluxes of the three primary colors of R, G and B split by the dichroic mirrors 16 and 17 enter polarization beam splitters 1R, 1G and 1B, respectively. In this instance, the liquid crystal panels 13R, 13G and 13B are disposed at positions from which the S polarized light beams are introduced to the metal grid structure faces 4a of the polarization beam splitters 1R, 1G and 1B.

The R light transmitted through the dichroic mirror 17 is polarized and split by the polarization beam splitter 1R. Thus, only the S polarized light of the R light is reflected by the polarization beam splitter 1R and directed to the reflection type liquid crystal panel 13R. The reflection type liquid crystal panel 13R modulates the incoming light with the R video signal applied thereto and emits the modulated light. The P polarized light of the outgoing light from the reflection type liquid crystal panel 13R is selected by the polarization beam splitter 1R and enters the color synthesizing prism 15.

The G light reflected by the dichroic mirror 17 is polarized and split by the polarization beam splitter 1G, and only the S polarized light of the G light is reflected by the polarization beam splitter 1G and directed to the reflection type liquid crystal panel 13G. The reflection type liquid crystal panel 13G modulates the incoming light with the G video signal applied thereto and emits the modulated light. The P polarized light of the outgoing light from the reflection type liquid crystal panel 13G is selected by the polarization beam splitter 1G and enters the color synthesizing prism 15.

The B light transmitted through the dichroic mirror 16 is reflected by the mirror 18 and then polarized and split by the polarization beam splitter 1B, and only the S polarized light of the B light is reflected by the polarization beam splitter 1B and directed to the reflection type liquid crystal panel 13B. The reflection type liquid crystal panel 13B modulates the incoming light with the B video signal applied thereto and emits the modulated light. The P polarized light of the outgoing light from the reflection type liquid crystal panel 13B is selected by the polarization beam splitter 1B and enters the color synthesizing prism 15.

The color synthesizing prism 15 synthesizes the incoming R, G and B light fluxes and emits them toward the same direction. Consequently, the synthesized light is magnified and projected as a color video by the projection lens 14.

In the case of the present configuration, when the synthesized light is magnified and projected by the projection lens 14, astigmatism appears because of an air gap 6 in each of the polarization beam splitters 1R, 1G and 1B. This deteriorates the video quality when compared with that by the configuration of FIG. 9. However, the deterioration is not considerable if the gap width of the air gap 6 is small.

Further, the configuration of FIG. 10 has an advantage in that the configuration of the optical system is less strict because the locations of the reflection type liquid crystal panels, particularly, the locations of the reflection type liquid crystal panels 13R and 13B, can be spaced away from the projection lens 14.

Usually, the distance from the projection lens 14 to the liquid crystal panel 13 is called back focus, and as the back focus decreases, a smaller size projection lens can be used, resulting in advantages for miniaturization and reduction in cost. In order to decrease the back focus in the configuration of FIG. 9, it is desirable to locate the reflection type liquid crystal panels 13R and 13B at positions as near as possible to the projection lens 14. Actually, however, this is sometimes very difficult from the alignment of the reflection type liquid crystal panels 13R and 13B in the optical system. On the other hand, where such a configuration as shown FIG. 10 is employed, the alignment of the reflection type liquid crystal panels 13R and 13B in the optical system is not difficult from a positional relationship to the projection lens 14.

While several examples of the configuration of the optical system for a liquid crystal projector apparatus are described above with reference to FIGS. 7 to 10, where the polarization beam splitter 1 having the configuration described above is utilized, a high polarization splitting function is obtained. Consequently, an optical system for a reflection type liquid crystal projector which projects and displays a bright image of a high quality in a high efficiency can be implemented using the polarization beam splitter 1.

Further, since the wire grid polarization splitting device 4 has also a characteristic that it does not have wavelength selectivity, a common polarization beam splitter device can be applied to the polarization beam splitters 1R, 1G and 1B corresponding to R light, G light and B light, respectively. This is advantageous for the production efficiency and reduction of the cost.

It is to be noted that the polarization beam splitters of the configurations described hereinabove with reference to FIGS. 1A to 6B can be adopted for the polarization beam splitters 1, 1R, 1G and 1B for use with a liquid crystal projector apparatus in accordance with the design of the optical system for use with them.

While a preferred embodiment of the present invention has been described using specific terms, such description is for illustrative purposes only, and it is to be understood that changes and variations may be made without departing from the spirit or scope of the following claims.

What is claimed is:

1. A polarization beam splitter comprising:
a first glass prism formed from a pole-like member having side faces which include first and second end faces each of which functions as an incoming face or an outgoing face of light and an opposing face;
a second glass prism formed from a pole-like member having side faces which include first and second end faces each of which functions as an incoming face or an outgoing face of light and an opposing face; and
a wire grid polarization splitting device formed from a glass substrate and a metal grid formed on a face of said glass substrate;
said wire grid polarization splitting device being fixed, at a face of said glass substrate thereof on which said metal grid is not formed, to the opposing face of said first glass prism;
said second glass prism being disposed so as to oppose, at the opposing face thereof, to the opposing face of said first glass prism to which said wire grid polarization splitting device is fixed in such a manner that an air layer is formed between the opposing faces.

2. The polarization beam splitter according to claim 1, wherein said first and second glass prisms are fixed at upper and bottom faces of the pole-like members thereof to fixing plates such that the opposing faces of said first and second glass prisms are disposed fixedly relative to each other with the air layer formed therebetween.

3. The polarization beam splitter according to claim 1, wherein end portions of the opposing faces of said first and second glass prisms or end portions of said wire grid polarization splitting device fixed to the opposing face are fixed to spacers such that the opposing faces are disposed fixedly relative to each other with the air layer formed therebetween.

4. The polarization beam splitter according to claim 1, further comprising a second wire grid polarization splitting device formed from a glass substrate and a metal grid formed on a face of said glass substrate, said second wire grid polarization splitting device being fixed, at a face of said glass substrate thereof on which said metal grid is not formed, to the opposing face of said second glass prism.

5. A liquid crystal projector apparatus, comprising:
a light source;
a reflection type liquid crystal panel for forming an optical image by modulating an incoming light in response to a video signal;
a projection lens; and
a polarization beam splitter for polarizing and splitting process light introduced along a predetermined light path from said light source and introducing the resulting light to said reflection type liquid crystal panel and for polarizing and splitting the light reflected by said reflection type liquid crystal panel and introducing the resulting light to said projection lens;
said polarization beam splitter including a first glass prism formed from a pole-like member having side faces which include first and second end faces each of which functions as an incoming face or an outgoing face of light and an opposing face, a second glass prism formed from a pole-like member having side faces which include first and second end faces each of which functions as an incoming face or an outgoing face of light and an opposing face, and a wire grid polarization splitting device formed from a glass substrate and a metal grid formed on a face of said glass substrate;
said wire grid polarization splitting device being fixed, at a face of said glass substrate thereof on which said metal grid is not formed, to the opposing face of said first glass prism;
said second glass prism being disposed so as to oppose, at the opposing face thereof, to the opposing face of said first glass prism to which said wire grid polarization splitting device is fixed in such a manner that an air layer is formed between the opposing faces.

6. The liquid crystal projector apparatus according to claim 5, wherein said predetermined light path includes splitting optical means for splitting white light from said light source into red, green, and blue light fluxes, said reflection type liquid crystal panel including first, second and third reflection type liquid crystal panels for forming an optical image in response to video signals of red, green and blue colors, said polarization beam splitter includes first, second and third polarization beam splitters which correspond to the red, green and blue light fluxes split by said splitting optical means and said first, second and third reflection type liquid crystal panels, respectively, said liquid crystal projector apparatus further comprising light synthesizing means for synthesizing the red, green and blue light fluxes reflected by said first to third reflection type liquid crystal panels and polarized and split by said first to third polarization beam splitters and introducing the synthesized light to said projection lens.

7. The liquid crystal projector apparatus according to claim 5, wherein said polarization beam splitter is disposed so that the light from said light source irradiates said reflection type liquid crystal panel by passing said second glass prism through said first glass prism and the light modulated by said reflection type liquid crystal panel is reflected on said wire grid polarization splitting device and is output to said projection lens.

8. The liquid crystal projector apparatus according to claim 5, wherein said first and second glass prisms of said polarization beam splitter are fixed at upper and bottom faces of the pole-like members thereof to fixing plates such that the opposing faces of said first and second glass prisms are disposed fixedly relative to each other with the air layer formed therebetween.

9. The liquid crystal projector apparatus according to claim 5, wherein end portions of the opposing faces of said first and second glass prisms of said polarization beam splitter or end portions of said wire grid polarization splitting device fixed to the opposing face are fixed to spacers such that the opposing faces are disposed fixedly relative to each other with the air layer formed therebetween.

10. The liquid crystal projector apparatus according to claim 5, wherein said polarization beam splitter further includes a second wire grid polarization splitting device formed from a glass substrate and a metal grid formed on a face of said glass substrate, said second wire grid polarization splitting device being fixed, at a face of said glass substrate thereof on which said metal grid is not formed, to the opposing face of said second glass prism.
